(19) United States
(12) Patent Application Publication
(10) Pub. No.: US 2018/0216377 A1
(43) Pub. Date: Aug. 2, 2018

(54) ELECTROMECHANICAL LOCK CONFIGURATION

(71) Applicant: SafeCorp Financial Services Pty Ltd., Victoria (AU)

(72) Inventors: Peter TRAN, Braeside (AU); Katherine BEDNARZ, Braeside (AU)

(21) Appl. No.: 15/420,760

(22) Filed: Jan. 31, 2017

(51) Int. Cl. E05C 9/02; E06B 9/11; E05D 15/16; E05F 15/668; E05F 15/77; E05C 1/08; E05C 17/60

(52) U.S. Cl. CPC E05C 9/021; E06B 9/11; E05D 15/165; E06B 2009/002; E05F 15/77; E05C 1/08; E05C 17/60; E05F 15/668

(57) ABSTRACT

Exemplary embodiments include an electromechanical lock configuration for use in locking, particularly curtain type doors typically used to close garage spaces but also used for closure of industrial and commercial spaces for alternative purposes. Aspects of the electromechanical lock configuration may also find applications in locking of other closure doors or panel members whether they be of the curtain door type. The electromechanical lock configuration includes a latchable restraining mechanism that includes a latch bolt assembly having a linearly movable latch bolt movable between a withdrawn position and an extended active position that restrains the door or closure from moving from the closed position. The latch bolt assembly includes a selectively operable electrically activated latch drive for moving the latch bolt between a withdrawn position and an extended active position through a drive gear. A manual override is also included.

### FIELD OF THE INVENTION

The invention relates to an electromechanical lock configuration for use in locking particularly curtain type doors typically used to close garage spaces but also used for closure of industrial and commercial spaces for alternative purposes. Aspects of the electromechanical lock configuration may also find applications in locking of other closure doors or panel members whether they be of the curtain door type or not.

### BACKGROUND TO THE INVENTION

Curtain doors commonly comprise thin formed sheet metal members spanning the door opening zone and hinged together so that they can be formed into a roll stored above the door opening zone when the door is open and extended to fully cover the door opening zone when the door is closed. In the closed state and when being moved to the closed state, lateral edges of the hinged sheet metal members are held in inwardly facing C-shaped channel members typically sandwiched between slide strips. In a known alternative form of curtain door, rigid panel members of a significantly wider dimension are hinged together along adjacent edges spanning the door opening zone. The panel members are supported by roller members adapted to roll along inwardly facing C-shaped channel members forming a guide track for the rollers. Because the rigid panel members are too wide to be rolled into a tight roll configuration in the open stage of the door, the guide tracks are configured to move the panel members from a vertical disposition when closing the door opening space to a generally horizontal position adjacent to or parallel to a ceiling inwardly of the door opening zone when in an open configuration.

Most commonly, curtain doors of the aforementioned kind are either moved between the open and the closed configurations either manually or by means of a remotely controlled drive motor. When the curtain door is moved manually, it is typically lockable in the closed position by means of a key operated lock mechanism mounted centrally intermediate its lateral edges, and intermediate its lower edge and an upper edge of the door opening zone. The lock mechanism typically throws locking bars outwardly towards a surround location to have laterally outermost regions of the locking bars retained in a stationary retaining zone in the surround to restrain the door or withdraws the locking bars laterally inwardly to free the door for movement towards an open disposition. More commonly, a remotely controlled drive motor is used to move the door and when such a drive motor is employed, the drive motor is used as a brake to effectively prevent the curtain door being forced opened without use of the remote control actuator or by use of an override arrangement from the inside.

Curtain doors of the above discussed type are widely in use and have numerous advantages including that they are capable of spanning relatively large door opening zones relatively cheaply. The doors are convenient in use, particularly when driven by a remotely controlled motor. They can, however, be relatively weak when forced compressively, for example, by an upwardly directed force on a lower edge zone of the door curtain. The panels or members of the door construction can crumple or the motor acting as a brake can fail, leading to the possibility of unwanted access through the door.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

An objective is to improve lock configurations, particularly for use with curtain type doors. It is a further objective to improve the security of curtain type doors when in the closed and locked position.

Throughout this specification including the claims, reference is made to “curtain doors” or “curtain type doors” and these phrases are intended to identify any known door structure where the structure is made up of members that are at least partially hinged to one another where the members can be extended into substantially a single plane spanning an open door region that is desired to be selectively closed, or can be rolled, folded (for example in concertina fashion) or slid to a second (for example horizontal disposition) location where the open door region is open.

### SUMMARY OF THE INVENTION

In a first aspect, the present invention provides a latchable restraining mechanism for restraining a closure means in a closed state spanning, in use, an opening zone having a stationary surround structure, said latchable restraining mechanism including a latch bolt assembly having a linearly movable latch bolt movable between a withdrawn position and an extended active position whereby, in use, in said extended active position, a free end of said latch bolt engages in a position to restrain said closure means from moving from the closed position, said latch bolt assembly further including selectively operable electrically activated latch drive means drivingly connected via drive coupling means to said latch bolt to move said latch bolt between said withdrawn position and said extended active position, said drive coupling means including a drive gear drivingly engaging with a first gear rack, said first gear rack forming part of or coupled to said latch bolt whereby rotation of said drive gear by said latch drive means results in linear movement of said latch bolt, said latchable restraining mechanism further including manual override means manually accessible from an external position to enable the first gear rack to be moved to move said latch bolt from said extended active position to said withdrawn position.

The latchable restraining mechanism may further include a second gear rack coupled to said drive gear whereby external manipulation of said second gear rack enables the latch bolt to be manually moved to the withdrawn position.

The latchable restraining mechanism may further include a second gear engaged with said first gear rack and a second gear rack engageable with said second gear whereby external manipulation of said second gear rack enables the latch bolt to be manually moved to the withdrawn position.

The latchable restraining mechanism may include housing support means supporting said latch bolt assembly, said housing support means including mounting means to enable the latchable restraining mechanism to be mounted, in use, to said stationary surround whereby in said extended active position, the free end of said latch bolt extends into said opening zone.

The latchable restraining mechanism may also include a striker plate means adapted, in use, to be mounted to said closure means, said striker plate means including operative or recess means into which the free end of said latch bolt extends when the latch bolt is in the extended active position and said closure means is in said closed state.

The striker plate may be formed from sheet metal having a first portion in a first plane securable, in use, to said closure means adjacent to an edge region of said closure means, said striker plate having a second portion in a second plane bent from said first portion, and a third portion bent from said second portion back towards said first plane, the aperture or recess being formed at least in said third portion.

The latchable restraining mechanism may also include control means and an electrical power source to drive said electrically activated drive means, said control means including sensor means to establish limit positions of said latch bolt in said extended active position and in said withdrawn position. In this regard, the sensor means may include limit micro switches.

In a second aspect, the present invention provides a latchable restraining mechanism for restraining a closure means in a closed state spanning, in use, an opening zone having a stationary surround structure, said latchable restraining mechanism including a latch bolt assembly having a linearly movable latch bolt movable between a withdrawn position and an extended active position whereby, in use, in said extended active position, a free end of said latch bolt engages in a position to restrain said closure means from moving from the closed position, said latch bolt assembly further including selectively operable electrically activated latch drive means drivingly connected via drive coupling means to said latch bolt to move said latch bolt between said withdrawn position and said extended active position, housing support means supporting said latch bolt assembly, said housing support means including mounting means enabling the latchable restraining mechanism to be mounted, in use, to said stationary surround whereby in said extended active position, the free end of said latch bolt extends into said opening zone.

The latchable restraining mechanism may further include a striker plate means adapted, in use, to be mounted to said closure means, said striker plate means including opening or recess means into which the free end of said latch bolt extends when the latch bolt is in the extended active position and said closure means is in said closed state.

In a third aspect, a latchable restraining mechanism is provided for restraining a closure means in a closed state spanning, in use, an opening zone having a stationary surround structure, said latchable restraining mechanism including a latch bolt assembly having a linearly movable latch bolt movable between a withdrawn and an extended active position whereby, in use, in said extended active position, a free end of said latch bolt engages in a position to restrain said closure means from moving from the closed position, said latch bolt assembly further including selectively operable electrically activated latch drive means drivingly connected via drive coupling means to said latch bolt to move said latch bolt between said withdrawn position and said extended active position, said latchable restraining mechanism further including control means and an electrical power source to drive said electronically activated drive means, said control means including sensor means to establish limit positions of said latch bolt in said extended active position on said withdrawn position.

In one embodiment, the sensor means comprises limit micro switches. Further, the electrical power source may be provided by electrical batteries.

In a still further aspect, a curtain door configuration is provided for closing and enabling access through an opening zone, said curtain door configuration having:
a curtain door assembly having laterally opposed edge regions cooperable with a respective guide track on opposed sides of the opening zone;
a selectively drivable first drive motor for moving said curtain door assembly at least between positions closing said opening zone and enabling access through said opening zone;
at least one latchable restraining mechanism for mechanically restraining the curtain door assembly in a closed state spanning, in use, said opening zone, said latchable restraining mechanism including a latch bolt assembly having a linearly movable latch bolt movable between a withdrawn position and an extended active position, a free end of said latch bolt engaging in a position to restrain said curtain door assembly from moving from the closed state, said latch bolt assembly further including a selectably drivable second electric motor drivingly connected via drive coupling means to said latch bolt to move said latch bolt between said withdrawn position and said extended active position; and
control means for selectively activating both said first drive motor and said second drive motor.

The control means may include a remote actuation system which activates said second electric motor at the same time or prior to said first electric motor.

The curtain door configuration may further include housing support means supporting said latch bolt assembly, said housing support means including mounting means to enable the latchable restraining mechanism to be mounted, in use, to a said guide track whereby in said extended active position, the free end of said latch bolt extends into said opening zone.

The or each said latchable restraining mechanism is preferably cooperable with a said laterally opposed edge region of the curtain door assembly adjacent a lower edge zone of the curtain door assembly.

In a preferred embodiment, two said latchable restraining mechanisms are provided, a said latchable restraining mechanism being cooperable with each said laterally opposed edge region of the curtain door assembly.

The curtain door configuration may further include manual override means manually accessible only from an internal side of said opening zone, said manual override means enabling said latch bolt to be manually moved from the extended active position to said withdrawn position.

The drive coupling means may include a first drive gear drivingly engaged with a first sliding gear rack, said first gear rack forming part of or coupled to said latch bolt whereby rotation of said first drive gear by said second electric motor results in linear movement of said latch bolt.

A second gear rack may be coupled to said first drive gear whereby external manipulation of said second gear rack enables the latch bolt to be manually moved to the withdrawn position.

The curtain door configuration may further include a second gear engaged with said first gear rack and a second gear rack engageable with said second gear whereby external manipulation of said second gear rack enables the latch bolt to be manually moved to the withdrawn position.

In yet another aspect, a lockable curtain door configuration is provided for closing and locking a door opening zone having a lower horizontal edge zone, an upper horizontal edge zone, and opposed laterally spaced upright edge zones, said lockable curtain door configuration including:
a door assembly with lateral edge zones adapted, in use, to span said door opening zone;
guide tracks adjacent each of a pair of opposed said edge zones of the door opening zone, each of said guide tracks facing inwardly towards said door assembly, with each said guide track receiving a said lateral edge zone of the door assembly for movement there along;
a latch bolt assembly including a latch bolt movable from a withdrawn position to an active latching position wherein in said active latching position a free end region of said latch bolt extends into said door opening zone, said latch bolt assembly further including electrically operated latch drive means to selectably drive said latch bolt between said withdrawn position and said active latching position;
striker plate means carried by said door assembly including a restraining opening into which said free end region of the latch bolt extends when in said active latching position; and
selectively operable control means adapted to control operation of said latch drive means.

### BRIEF DESCRIPTION OF THE DRAWINGS

FIG. 1 is an exploded perspective view of a latch restraining mechanism according to one preferred embodiment;

FIG. 2 is a partially assembled perspective view of the latch restraining mechanism (cover omitted) shown in FIG. 1;

FIG. 3 is an elevation view of FIG. 2 with the batteries omitted;

FIG. 4 is an exploded perspective view of the latch restraining mechanism (cover omitted) taken from the opposite side of FIG. 2;

FIG. 5 is an assembled view of the parts shown in FIG. 4;

FIG. 6 is an elevation view of the parts shown in FIG. 5;

FIG. 7 is an exploded perspective view similar to FIG. 2 but including the cover;

FIG. 8 is a view similar to FIG. 7 but from the opposite direction;

FIGS. 9 and 10 are views similar to FIG. 2 but showing the latch bolt and therefore the contact for the position sensing micro switches in different positions;

FIG. 11 is a perspective view showing the latch restraining mechanism and cooperating striker plate in a position of use;

FIG. 12 is a plan view showing the assembly indicated in FIG. 11; and

FIG. 13 is an exploded perspective view of the striker plate shown in FIGS. 11 and 12.

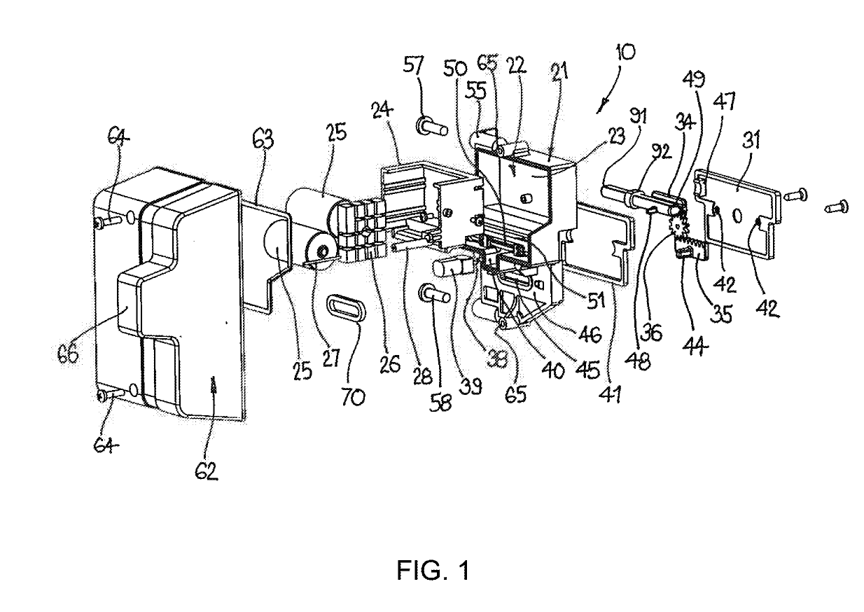

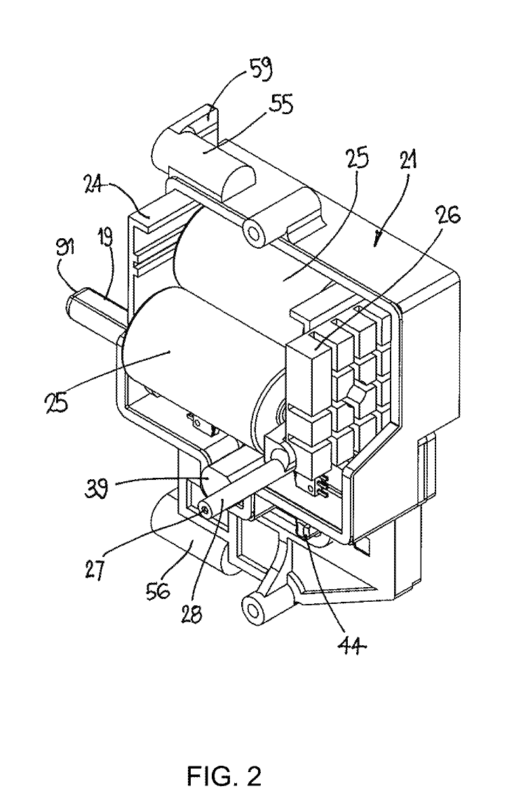

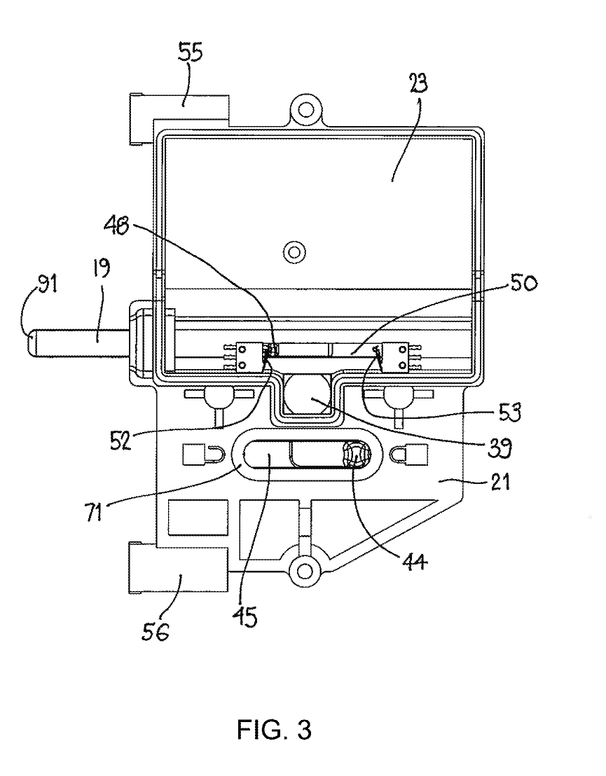

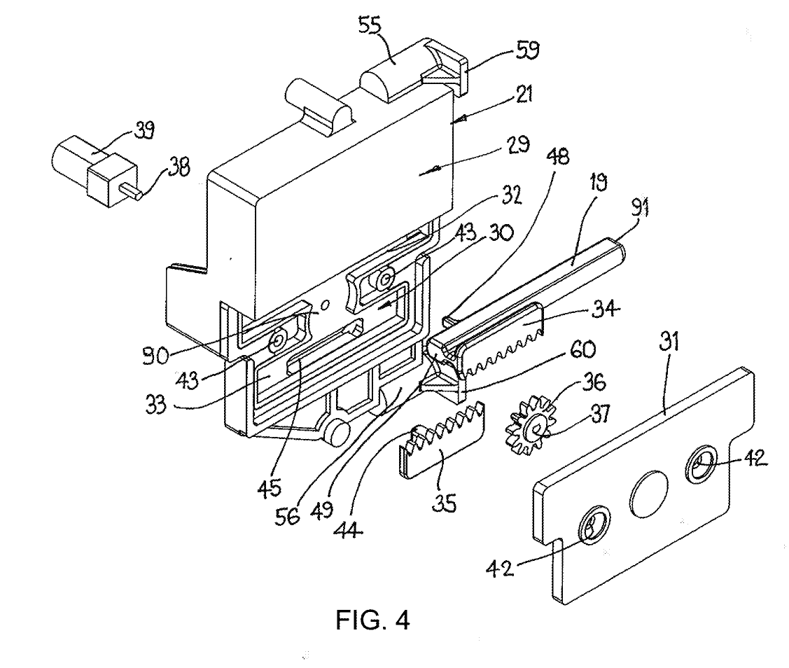

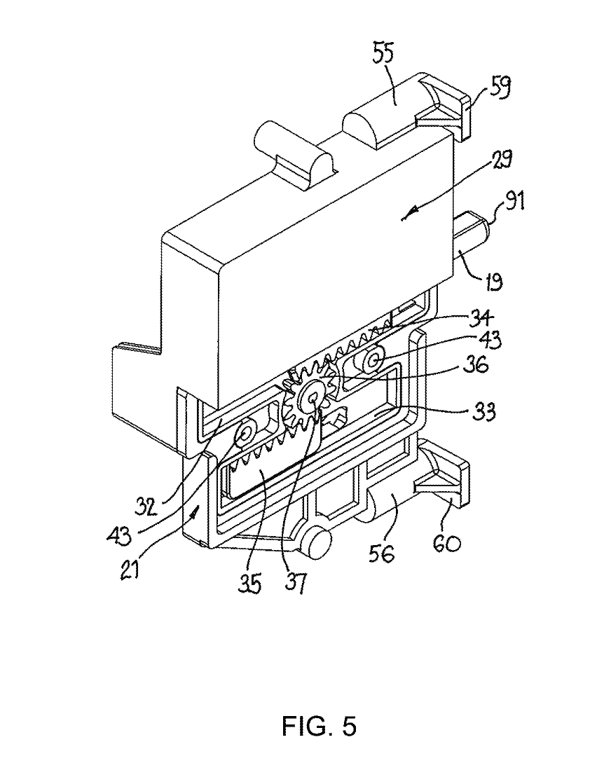

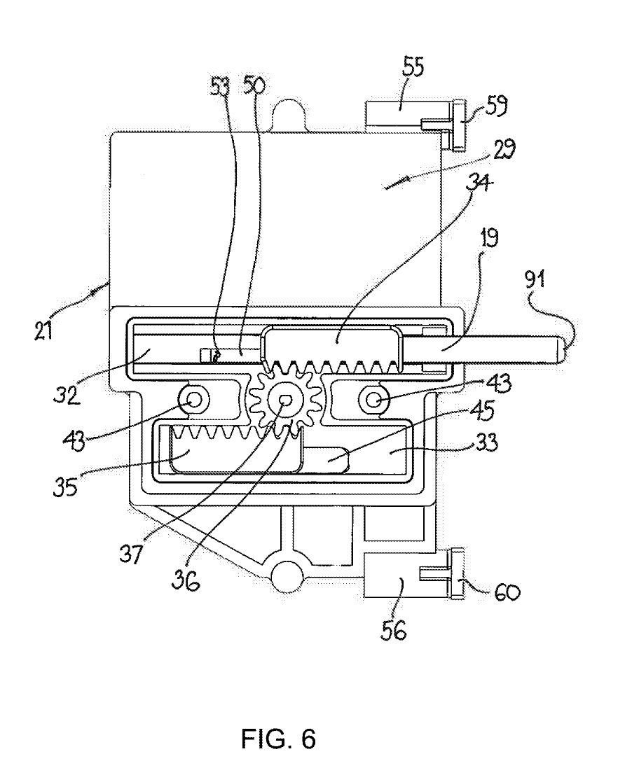

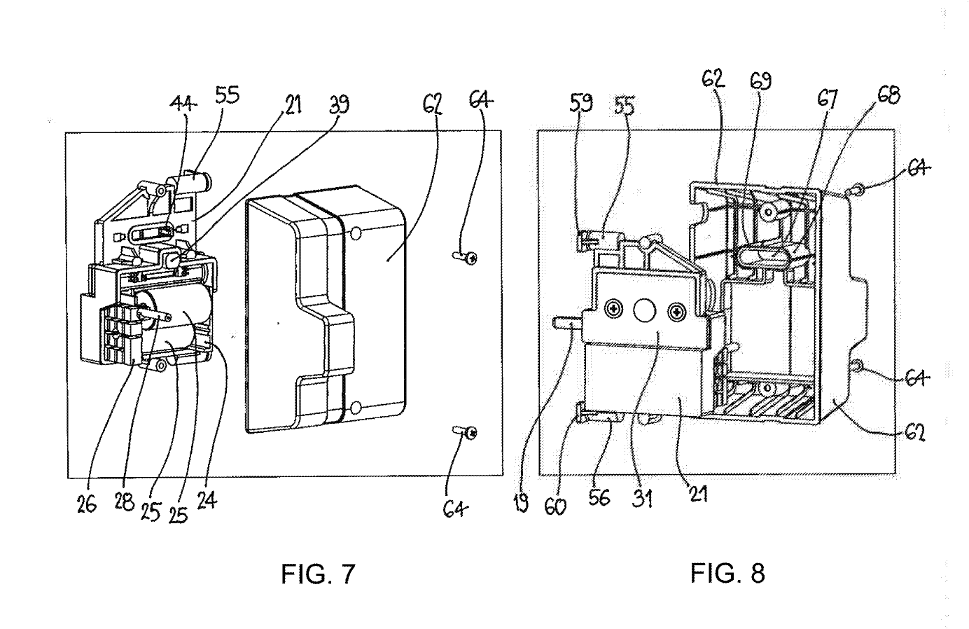

### DESCRIPTION OF THE PREFERRED EMBODIMENTS SHOWN IN THE

DRAWINGS

The annexed drawings represent one preferred embodiment of a latchable restraining mechanism 10 used with a curtain type door 11 lifted or lowered by a drive motor (not shown in the drawings) in the usual manner and operated by a remote control system and associated actuator.

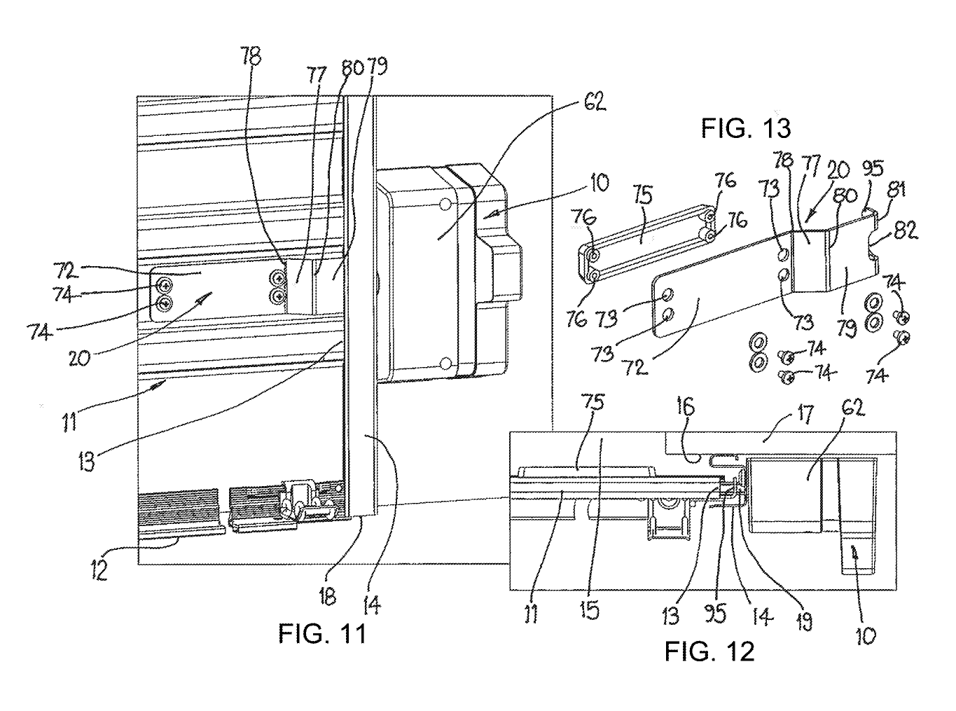

The curtain type door 11 may be of any known type as discussed earlier in this specification. FIG. 11 partially shows the curtain type door 11 having a lower edge 12 with one of its vertical edge zones 13 captured in and movable along an upright guide track 14 comprised of a generally C-shaped channel section facing inwardly toward the door opening zone 15 intended to be closed and opened by the door 11. The guide track 14 is typically mounted side surface 16 of a building structure 17 surrounding the opening zone 15. The latchable restraining mechanism 10 is operationally mounted adjacent to the lower end 18 of the guide track 14 which is also adjacent the lower edge 12 of the curtain type door 11. Preferably two such latchable restraining mechanisms 10 are used, one on each side of the door 11 and both adjacent the lower edge 12 of the door 11. Conveniently, the or each latch restraining mechanism 10 has a latch bolt 19 cooperable with a striker plate 20 secured to the lower region of the curtain type door 11 adjacent to but inwardly from a side edge zone 13, the structure and nature of the latch bolt 19 and striker plate 20 will be described in greater detail in the following.

The or each latch restraining mechanism 10 includes a base housing support structure 21 which may be formed by die casting from a suitable metal for strength and rigidity, however, certain plastics materials might also be employed. The forward (in use) side 22 of the housing support structure 21 has a first cavity zone 23 adapted to receive and mount a battery casing 24 adapted, in use, to operationally mount batteries 25. Typically C type batteries are used but it is also possible to use AA batteries. The battery casing 24 is typically moulded from an electrically insulating material such as a suitable plastics material. The first cavity zone 23 also has sufficient space adjacent the battery casing 24 to enable mounting of a power control board (PCB) 26 acting as a control device for the latch restraining mechanism 10. An antenna 27 and support structure 28 for the antenna 27 is mounted between the batteries 25 and the PCB 26 such that the antenna 27 extends in a forward direction. The antenna 27 allows a signal from a remote control actuator (not shown) to be picked up and via the PCB 26, controls operation of the latch restraining mechanism 10 in response thereto.

On a rearwardly facing side 29 (in use) of the housing support structure 21, a second cavity zone 30 is formed covered by a cover plate 31. A sealing gasket 41 might be positioned between the cover plate 31 and the housing support structure 21. Conveniently screw fasteners are passed through openings 42 in the cover plate 31 and openings 43 in the housing support structure 21 to connect the cover plate 31 to the housing support structure 21. The second cavity zone 30 comprises an upper section 32, a lower section 33 with the sections 32, 33 being joined by an intermediate section 90. Each of the upper and lower cavity zone sections 32 and 33 are designed as a slide track to house a gear rack member 34 or 35 to slide in parallel directions therealong. The gear rack members 34, 35 have their gear teeth facing toward one another and engagable with a pinion gear 36 located in the intermediate section 90. The pinion gear 36 has a central, non-circular bore 37, through which a correspondingly shaped drive shaft 38 of a drive motor 39 is passed. The drive motor 39 is mounted in a correspondingly shaped section 40 of the forwardly facing cavity zone 23 whereby the motor drive shaft 38 passes into the rearwardly facing intermediate section 90 of the second cavity zone 30.

The lower gear rack member 35 has a forwardly extending grip projection 44 extending through an elongated slot 45 in the forwardly facing wall 46 forming the rear wall of the rearwardly facing cavity section 33 such that the projection 44 can be gripped or engaged from the forward side of the housing support structure 21 to enable the gear rack member 35 to be manually moved along its slide track and in so doing rotate the pinion gear 36 against any forces applied by the drive motor 39.

The upper gear rack member 34 is integrally formed with the latch bolt 19 and consequently any sliding movement of the gear rack member 34 causes a corresponding movement of the latch bolt 19. While integral forming of this part is preferred, it is also possible to fabricate the part from separate pieces to be assembled. The latch bolt 19 has a free end 91 engagable, in use, with the striker plate 20 secured to the door 11. The latch bolt 19 includes an enlarged section 92 spaced from the end of the free end 91 to act as a limit stop to prevent the latch bolt from extending outwardly from the housing support structure 21 too far. The enlarged section 92 engages with abutments 47 on the cover member, the housing support structure 21, or both.

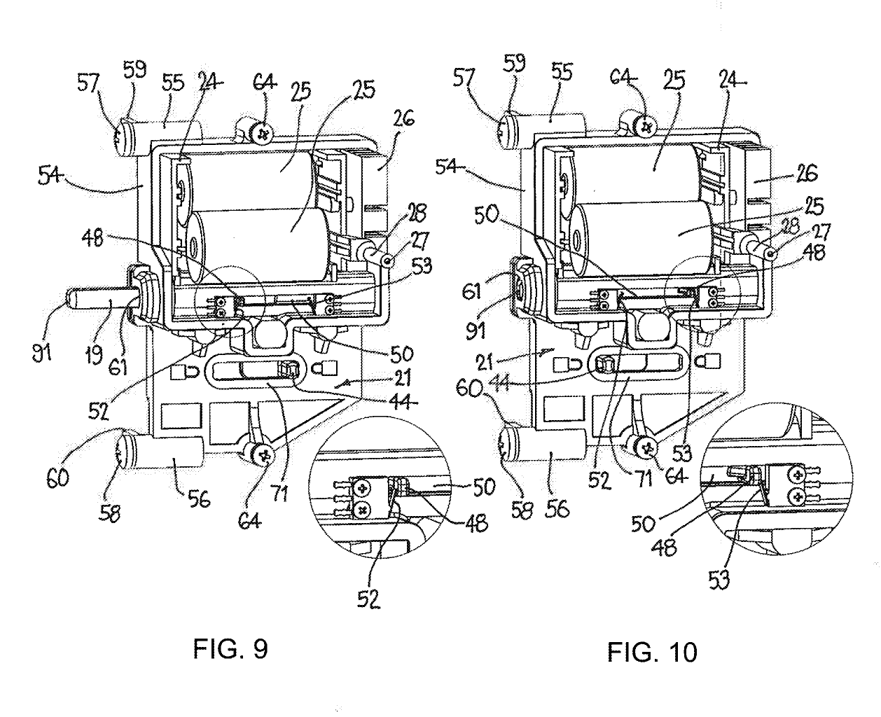

The latch bolt 19 further includes a forwardly, in use, extending projection 48 positioned between the enlarged section 92 and an inner end 49 of the latch bolt 19. The projection 48 moves with the latch bolt 19 and extends through a slot 50 in a wall 51 of the housing support structure 21. As can be seen in FIGS. 9 and 10, the projection 48 engages at opposed ends of the slot 50 with micro switches 52, 53 as an electro mechanical means of determining the position of the latch bolt 19, i.e. in the fully extended latching position or the withdrawn non latching position. This provides an input to the control means (PCB 26) when a person sends a signal via a remote actuator to the apparatus to either close or open the door 11.

The housing support structure 21 has on one side wall 54 a mounting structure comprised of spaced bosses 55, 56, each with a threaded bore to receive a fastener 57, 58. Conveniently a laterally extending flange 59, 60 increases the contact surface area around the threaded bores to increase stability of the housing support structure 21 when mounted to a surface of the web of the channel shaped guide track 14. The free end 91 of the latch bolt 19 projects through an opening 61 in the side wall 54 of the housing support structure 21. The spaced threaded bores in the mounting bosses 55, 56 and the opening 61 are sufficiently aligned such that to mount the housing support structure to a guide track 14, all that is required is to drill three suitably positioned holes in the web of the channel section forming the guide track 14. The upper and lower holes permit fasteners 57, 58 to secure the housing support structure 21 to the guide track 14. The intermediate hole permits the free end 91 of the latch bolt 190 pass therethrough. Essentially the same latchable restraining mechanism 10 can be secured to both sides of a door 11 by rotating the mechanism 10 through 180°.

A cover member 62 is formed as a shell and is arranged to cover the forwardly facing (in use) side of the housing support structure 21. A seal gasket 63 seals the contacting edges of the cover member 62 and the rim surrounding the first cavity zone 23. The cover member 62 is secured by fasteners 64 to the housing support structure by being threaded into threaded bores 65. The cover member 62 includes an enlarged zone 66 to provide space to cover the PCB 26 and the antenna 27. Conveniently a slot 67 surrounded by a depending wall 68 might be provided through the outer shell of the cover member 62 (FIG. 8) with the edge 69 of the depending wall 68 being sealed by gasket means 70 to a seal surface 71 on the housing support structure 21. The slot 67 in the cover member 62 might be provided to give immediate access to the override mechanism including the manually movable projection 44. In an alternative arrangement, access to the projection 44 might be provided by requiring removal of the cover member 62. As use of the override mechanism would not be required commonly, the removal of two screws to remove the cover member 62 is not a significant difficulty.

Referring now to FIGS. 11 to 13, the striker plate 20 may be formed by sheet or strip of metal formed as best seen in FIG. 13. The striker plate 20 has a first section 72 with mounting holes 73 permitting fasteners 74 to pass therethrough and through mounting holes in the door 11 to be secured in threaded bores 76 in a Fascia plate 75 positioned on the external side of the door 11. A second section 77 of the striker plate 20 is bent at 78 to form an angle with the first section 72. A third section 79 is bent at 80 forming a part that is generally parallel to the plane of the first section 72. A fourth section 95 is bent at 81 back towards the plane of the first section 72. A latch bolt receiving opening 82 is formed in the fourth section 95 and preferably also partially extending into the third section 79. Conveniently, the opening 82 does not extend fully to the end of the fourth section 80. Conveniently, the striker plate 20 and therefore the housing support structure 21 carrying the latch bolt 19 is intended to be mounted close to the lower edge 12 of the curtain type door 11. Preferably, in use, the height of the latch bolt 19 is no greater than 200 mm from the lower edge 12 of the curtain type door 11 when closed, and more preferably no greater than 100 mm from the lower edge 12 of the door 11 when closed.

While the drawings show a preferred embodiment, variations and modifications of same are possible within the scope of the annexed patent claims.

1. A latchable restraining mechanism for restraining a curtain door in a closed state spanning, in use, an opening zone having a stationary surround structure, said curtain door comprising laterally opposed edge regions cooperable with a respective guide track on opposed sides of said opening zone, said curtain door being moveable by a drive motor at least between positions closing said opening zone and enabling access through said opening zone, said latchable restraining mechanism comprising:
a latch bolt assembly having a linearly movable latch bolt movable between a withdrawn position and an extended active position whereby, in use, in said extended active position, a free end of said latch bolt engages in a position to restrain said curtain door from moving from the closed state; and said latch bolt assembly comprising a selectively operable electrically activated latch drive means drivingly connected via drive coupling means to said latch bolt to move said latch bolt between said withdrawn position and said extended active position, said latchable restraining mechanism being responsive to control means for selectively activating both said drive motor and said latch drive means,

2. (canceled)

3. (canceled)

4. The latchable restraining mechanism according to claim 1 further comprising housing support means supporting said latch bolt assembly, said housing support means comprising mounting means to enable the latchable restraining mechanism to be mounted, in use, to said stationary surround whereby in said extended active position, the free end of said latch bolt extends into said opening zone.

5. The latchable restraining mechanism according to claim 1, further comprising a striker plate means adapted, in use, to be mounted to said curtain door, said striker plate means comprising an aperture or recess means into which the free end of said latch bolt extends when the latch bolt is in the extended active position and said curtain door is in said closed state.

6. The latchable restraining mechanism according to claim 5 wherein said striker plate is formed from sheet metal having a first portion in a first plane securable, in use, to said curtain door adjacent to an edge region of said curtain door, said striker plate having a second portion in a second plane bent from said first portion, and a third portion bent from said second portion back towards said first plane, the aperture or recess being formed at least in said third portion.

7. The latchable restraining mechanism according to claim 1 further comprising an electrical power source to drive said electrically activated latch drive means.

8. The latchable restraining mechanism according to claim 26 wherein said sensor means comprises limit micro switches.

9. (canceled)

10. (canceled)

11. (canceled)

12. (canceled)

13. (canceled)

14. A curtain door configuration for closing and enabling access through an opening zone, said curtain door configuration comprising:
a curtain door assembly having laterally opposed edge regions cooperable with a respective guide track on opposed sides of the opening zone;
a selectively drivable first drive motor for moving said curtain door assembly at least between positions closing said opening zone and enabling access through said opening zone;
at least one latchable restraining mechanism for mechanically restraining the curtain door assembly in a closed state spanning, in use, said opening zone, said latchable restraining mechanism including a latch bolt assembly having a linearly movable latch bolt movable between a withdrawn position and an extended active position, a free end of said latch bolt engaging in a position to restrain said curtain door assembly from moving from the closed state, said latch bolt assembly further including a selectably drivable second electric motor drivingly connected via drive coupling means to said latch bolt to move said latch bolt between said withdrawn position and said extended active position; and
control means for selectively activating both said first drive motor and said second drive motor.

15. The curtain door configuration according to claim 14 wherein said control means comprises a remote actuation system.

16. The curtain door configuration according to claim 15 wherein the remote actuation system activates said second electric motor at the same time or prior to said first electric motor.

17. The curtain door configuration according to claim 14 further comprising housing support means supporting said latch bolt assembly, said housing support means comprising mounting means to enable the latchable restraining mechanism to be mounted, in use, to a said guide track whereby in said extended active position, the free end of said latch bolt extends into said opening zone.

18. The curtain door configuration according to claim 14 wherein the or each said latchable restraining mechanism is cooperable with a said laterally opposed edge region of the curtain door assembly adjacent a lower edge zone of the curtain door assembly.

19. The curtain door configuration according to claim 14 wherein two said latchable restraining mechanisms are provided, a said latchable restraining mechanism being cooperable with each said laterally opposed edge region of the curtain door assembly.

20. (canceled)

21. The curtain door configuration according to claim 14 wherein said drive coupling means comprises a drive gear drivingly engaged with a sliding gear rack, said first gear rack forming part of or coupled to said latch bolt whereby rotation of said first drive gear by said second electric motor results in linear movement of said latch bolt.

22. (canceled)

23. (canceled)

24. (canceled)

25. The latchable restraining mechanism according to claim 1 wherein said drive coupling means comprises a drive gear drivingly engaging with a gear rack, said gear rack forming part of or coupled to said latch bolt whereby rotation of said drive gear by said latch drive means results in linear movement of said latch bolt.

26. The latchable restraining mechanism according to claim 1 wherein said control means comprises a sensor means to establish limit positions of said latch bolt in said extended active position and in said withdrawn position.

27. The latchable restraining mechanism according to claim 1 wherein said control means includes a remote actuation system.

28. The latchable restraining mechanism according to claim 27 wherein the remote actuation system activates said latch drive means at the same time or prior to said drive motor
